(19) United States
(12) Patent Application Publication
(10) Pub. No.: US 2014/0191921 A1
(43) Pub. Date: Jul. 10, 2014

(54) SMALL ANTENNA APPARATUS FOR VEHICLE AND MANUFACTURING METHOD THEREOF

(71) Applicants: INFACS ELECS CO., LTD., Inchun (KR); Hyundai Motor Company, Seoul (KR)

(72) Inventors: Tae-Hoon Yang, Inchun (KR); Woo-Jin Kim, Pyungtaek (KR); Jae-Hoon Jung, Gunpo (KR); Min-Kyung Jang, Inchun (KR); Young-Min Lee, Kwangmyung (KR); Sang-Heun Lee, Seoul (KR); Young-Jin Choi, Youngin (KR); Ho-Young Cho, Youngin (KR); Keun-Ho Yang, Youngin (KR)

(73) Assignees: INFACS ELECS CO., LTD., Inchun (KR); Hyundai Motor Company, Seoul (KR)

(21) Appl. No.: 14/101,978

(22) Filed: Dec. 10, 2013

(30) Foreign Application Priority Data
Dec. 10, 2012 (KR) 10-2012-142572

(51) Int. Cl. H01Q 1/27; H01Q 1/42

(52) U.S. Cl. CPC H01Q 1/27; H01Q 1/42
USPC 343/872; 29/600

(57) ABSTRACT

An antenna device for a vehicle and a manufacturing method thereof are provided. The antenna device includes an antenna coil disposed in a helical antenna shape having a substantially constant pitch interval and a connector disposed on a first end of the antenna coil. A cylinder member, electrically connected to the antenna coil, is disposed on a second end of the antenna coil. A first fixing member covers a portion of the connector and the first end of the antenna coil to fix the antenna coil to the connector. A second fixing member is filled into a hollow portion and a gap within the substantially constant pitch interval and a third fixing member covers the second end of the antenna coil. A cover member covers the antenna coil, a portion of the connector, the cylinder member, the first fixing member, the second fixing member and the third fixing member.

### CROSS-REFERENCE TO RELATED APPLICATION

This application claims under 35 U.S.C. §119(a) the benefit of Korean Patent Application No. 10-2012-142572 filed Dec. 10, 2012, the entire contents of which are incorporated herein by reference.

### BACKGROUND

(a) Technical Field

The present disclosure relates to a small antenna apparatus for a vehicle and a manufacturing method thereof, and more particularly, a small antenna apparatus for a vehicle and a manufacturing method thereof in which the constitutional components are integrated and simplified to correspond with varying arranging environments and to minimize a manufacturing cost thereof.

(b) Background Art

In general, a small antenna for a vehicle refers to a device that receives radio broadcasting via a radio receiver disposed within a vehicle and a pole type helical antenna is commonly used as the small antenna. The pole type helical antenna has a spiral coil type configuration to produce resonance within a shorter length than the length of the antenna. The pole type helical antenna receives a broadcasting signal with producing resonance in a specific frequency based on a length and pitch thereof. In addition, the pole type helical antenna has a length of about 180-220 mm to smoothly receive the signal of radio frequency band region based on a modulation way of amplitude modulation (AM), frequency modulation (FM), etc.

A conventional pole type helical antenna, as shown in FIG. 1, includes: a rod 2 that fixes coil which consists of a hollow cylinder body through which an insertion bore one end of which is opened is formed along a center line at a predetermined length, and on an outer peripheral surface of which screw grooves each having a predetermined pitch are formed; an antenna coil 4 wound separately in a coil spring shape of a predetermined length, having the same pitch as the screw groove formed on the rod for fixing coil, and fitted into the screw groove of the rod to fix the coil to be in contact with the groove wherein a sectional shape thereof is different from the screw groove to be spaced from a valley of the screw groove to form a gap therebetween; a sheath 6 is integrally connected to the rod to fix the coil while surrounding the rod to fix the coil and in an inner peripheral surface of which the antenna coil fitted into the rod is disposed to be indented; and a rod that absorbs impact is formed in a bar shape made of flexible material, having a predetermined length, and is inserted into the insertion bore of the rod that fixes the coil.

According to the micro helical antenna of the related art, when the rod that fixes the coil into which the antenna coil is fitted and the sheath are deformed elastically due to an external force, the rod into which the antenna coil is fitted and the sheath are returned to original shapes by a returning force of the rod for absorbing impact, and when the rod into which the antenna coil is fitted and the sheath are deformed elastically or returned to original shapes, the location of the antenna coil is adjusted through the gap to be disposed at a regular position.

Further, a method of manufacturing the micro helical antenna in the related art includes the steps of: connecting a connector as a conductor formed in a coil spring shape of a predetermined length, having a predetermined pitch, to one end of the antenna coil 4 by welding; forming the rod 2 that fixes the coil in a shape of a hollow cylinder along a center line of which the insertion bore is formed at a predetermined length by placing a pin for a core in a longitudinal direction along a center line of a cavity and then inject-forming material into the cavity, using a mold for forming the rod of a predetermined length in a cylinder shape, having the cavity, and the pin for the core of a predetermined length in a bar shape. The screw threads having the same pitch as the antenna coil are formed on an inner peripheral surface of the mold for forming the rod, constituting an appearance of the cavity, to form the screw grooves on an outer peripheral surface of the rod for fixing coil.

In addition the method includes inserting the antenna coil along the screw grooves of the rod and fitting the antenna coil into the rod; forming a fixing piece to integrally connect one end of the antenna coil to one end of the rod by inserting one end of the rod into which the antenna coil is fitted, into the cavity of a mold to form the fixing piece and then inject-forming material into the cavity of the mold to form the fixing piece, using the mold for forming the fixing piece, having the cavity into which one end of the rod to be in contact with the connector of the antenna coil is inserted with a space; forming a sheath 6 that surrounds the rod into which the antenna coil is fitted, by inserting the rod and a core into the cavity of a mold for forming the sheath, to be connected, and then injecting molding material into the cavity of the mold for forming the sheath, using the mold for forming sheath, having the cavity into which the rod is inserted with a space, and the core wherein an aperture that is communicated to the insertion bore of the rod is formed in the sheath by the core; and inserting in sequence the rod for absorbing impact of a predetermined length in a bar shape into the insertion bore of the rod and the cap to close into an aperture of the sheath.

However, according to the pole type helical antenna of the related art as described above, the length of about 80-220 mm may be longer than the design of currently manufactured vehicles. Further, a spiral protrusion is disposed on an external part of a cover to prevent wind noise, thus limiting freedom degree of designing an appearance of the antenna.

In addition, in the conventional pole type helical antenna, when the antenna is fastened to a base 8, the connector of the antenna is screw-fastened to the base by rotating the pole type helical antenna several times, and the base 8 of the pole type helical antenna uses a base connector provided thereof and a separate terminal to connect the base connector to a conductive pad therein. However, when the separate terminal is used, the cost for the terminal increases and also separate processes for bonding the base connector and one end of the terminal and bonding the conductive pad and the other end of the terminal are required, thereby making the process complicated and increasing manufacturing cost thereof.

Furthermore, a conventional manufacturing method of a pole type helical antenna includes the steps of: an inject-forming a rod that fixes a coil or a bobbin on an outer peripheral surface of which screw-grooves each having a predetermined pitch are formed, using a mold for forming a rod and a pin for forming a core; connecting a coil spring to the rod using a mold for forming a fixing piece and then inject-forming the fixing piece to a connection part of the coil spring and a connector; and inject-forming a sheath that covers the entire antenna, except for a part of the connector, using a mold for forming the sheath. Accordingly, the conventional manufacturing method of a pole type helical antenna includes at least essential three processes thus making the process more complicated and increasing the manufacturing cost.

### SUMMARY

The present invention provides a substantially small antenna device for a vehicle and a manufacturing method thereof, in which the configurations of a connector connected to a pole type helical antenna, within a base, and a terminal connected to the connector are improved, to simplify the manufacturing process and reduce manufacturing costs.

In addition, the present invention provides a substantially small antenna device for a vehicle and a manufacturing method thereof, in which an inject-forming process of a bobbin is omitted to reduce the number of the components and to simplify the manufacturing process, thereby decreasing the price of the product. Further the present invention provides a substantially small antenna device for a vehicle and a manufacturing method thereof, in which an appearance of the antenna is improved and a freedom degree of designing the appearance of the antenna is increased by removing a spiral protrusion structure disposed on the exterior of a cover member to prevent wind noise.

Accordingly, a substantially small antenna device for a vehicle according to an exemplary embodiment of the present invention may include: an antenna coil arranged in a helical antenna shape having a substantially constant pitch interval; a connector arranged on one end of the antenna coil; a cylinder member arranged on the other end of the antenna coil and connected electrically to the antenna coil; a first fixing member configured to cover a portion of the connector and one end of the antenna coil to fix the antenna coil to the connector; a second fixing member filled into a hollow portion and a gap within the substantially constant pitch interval of the antenna coil; a third fixing member configured to cover the other end of the antenna coil; and a cover member configured to cover the antenna coil, a portion of the connector, the cylinder member, the first fixing member, the second fixing member and the third fixing member, wherein the first fixing member, the second fixing member and the third fixing member may be integrally formed.

The substantially small antenna device for a vehicle according to an exemplary embodiment of the present invention may further include a case to which the connector may be connected and the case may include a terminal integrated type case connector. In addition, the case connector may have an inter-fastening structure with respect to the connector; and a terminal may be integrally formed with the case connector and may be extended to one direction in a straight line shape. Further, the substantially small antenna device may include a base, an upper surface of which may be covered with the case.

The base may include a conductive pad electrically connected to the terminal; a printed circuit board configured to support the conductive pad; an antenna pad connected to a lower surface of the printed circuit board and configured to cover a lower surface of the case; a power input end that passes through the antenna pad to be connected to the printed circuit board and configured to supply power thereto; and an antenna output end arranged to be spaced from the power input end at a predetermined interval to pass through the antenna pad and form a wire path from the printed circuit board to exterior. The antenna pad may be arranged detachably to the base and a shape and thickness of the antenna pad may be formed variously based on the arranging locations of the antenna within different types of vehicles.

A manufacturing method of a substantially small antenna for a vehicle according to an exemplary embodiment of the present invention, may include: bonding a connector to one end of an antenna coil arranged in a helical antenna shape having a substantially constant pitch interval; bonding a cylinder member having a conductive pad electrically connected to the antenna coil to the other end of the antenna coil; integrally inject-forming a first fixing member configured to cover a portion of the connector and one end of the antenna coil to fix the antenna coil to the connector, a second fixing member filled into a hollow portion and a gap within the substantially constant pitch interval of the antenna coil, and a third fixing member configured to cover the other end of the antenna coil; and inject-forming a cover member configured to cover the antenna coil, a portion of the connector, the cylinder member, the first fixing member, the second fixing member and the third fixing member.

The manufacturing method of a substantially small antenna for a vehicle according to an exemplary embodiment of the present invention may further include providing a case that may include a case connector having an inter-fastening structure with respect to the connector; and a case connector integrated type terminal extended to one direction in a straight line shape. In addition, the base may include a printed circuit board an upper surface of which may be covered with the case, connected to a lower surface of the printed circuit board and having various preset shapes and thicknesses based on the arranging locations of the antenna in various types of vehicles.

### BRIEF DESCRIPTION OF THE DRAWINGS

The above and other features of the present invention will now be described in detail with reference to exemplary embodiments thereof illustrated the accompanying drawings which are given herein below by way of illustration only, and thus are not limitative of the present invention, and wherein:

FIG. 1 is an exemplary view showing a micro helical antenna according to a related art;

FIG. 2A is an exemplary front view showing a substantially small antenna device for a vehicle according to an exemplary embodiment of the present invention;

FIG. 2B is an exemplary right-side view showing a substantially small antenna device for a vehicle as shown in FIG. 2A according to an exemplary embodiment of the present invention;

FIG. 3A is an exemplary detailed view showing a substantially small antenna device for a vehicle as shown in FIG. 2A according to an exemplary embodiment of the present invention;

FIG. 3B is an exemplary bottom view showing a substantially small antenna device for a vehicle according to an exemplary embodiment of the present invention;

FIG. 4 is an exemplary cross-sectional view showing a substantially small antenna device for a vehicle as show in FIG. 2A according to an exemplary embodiment of the present invention;

FIGS. 5A-5D are exemplary views showing a manufacturing method of a substantially small antenna device for a vehicle as shown in FIG. 4 according to an exemplary embodiment of the present invention; and

FIG. 6 is an exemplary graph showing receiving performances of a substantially small antenna device for a vehicle according to an exemplary embodiment of the present invention and a helical antenna having a pole type antenna of about 200 mm according to a related art.

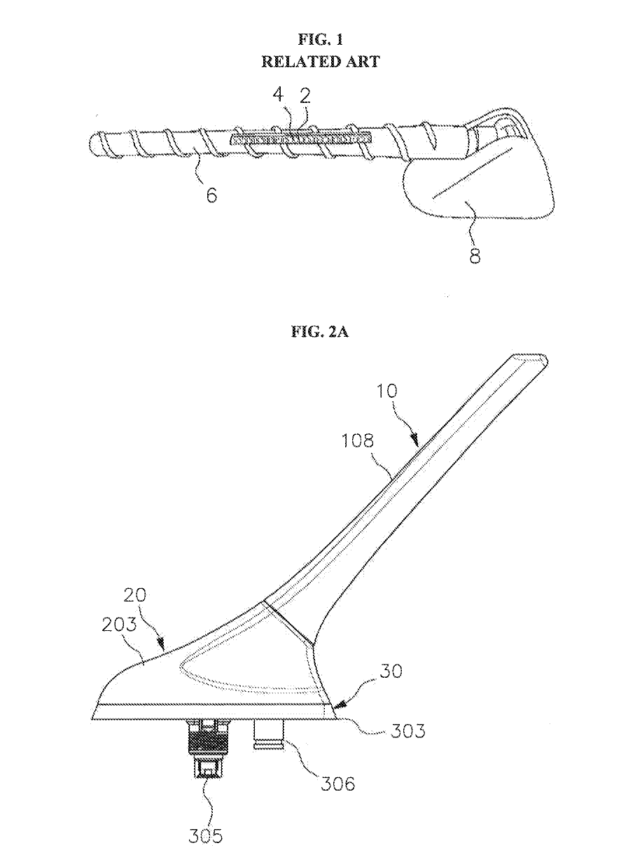

It should be understood that the accompanying drawings are not necessarily to scale, presenting a somewhat simplified representation of various features illustrative of the basic principles of the invention. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the accompanying claims, and all differences within the scope will be construed as being included in the present invention.

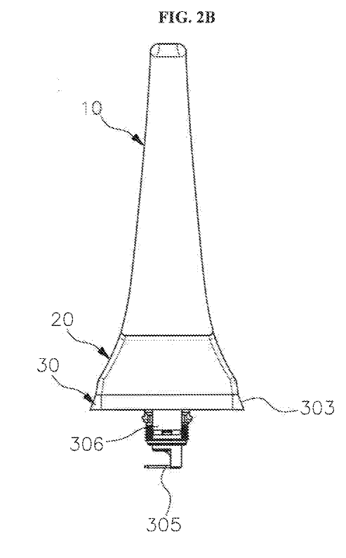

FIG. 2A is an exemplary front view showing a substantially small antenna device for a vehicle according to an exemplary embodiment of the present invention and FIG. 2B is an exemplary right-side view showing a substantially small antenna device for a vehicle as shown in FIG. 2A. Referring to FIGS. 2A and 2B, a substantially small antenna device according to an exemplary embodiment of the present invention may include an antenna 10, a case 20 and a base 30.

The antenna 10 may be a device in which a length of an antenna coil is determined as being about ¼ or ½ of a wavelength to be used, to radiate radio frequency efficiently or receive the radio frequency wherein the coil may have various shapes depending on the usage thereof or the frequency to be used. Meanwhile, a pole type helical antenna that receives a radio frequency from a radio disposed within a vehicle is commonly used and the antenna 10 of the exemplary embodiment of the present embodiment may be a type of a helical antenna having an improved structure and simplified manufacturing process.

The antenna 10 may include an antenna coil, a connector, a cylinder member, a first fixing member, a second fixing member, a third fixing member and a cover member 108. In particular, the cylinder member may have a conductive pad arranged to the other end of the antenna coil to profit of the antenna and condition of a radiation pattern, and the first to third fixing members may be integrally formed.

The case 20 may include a case connector, a terminal, and a case main body 203. In particular, the case 20 may be configured to partially house the antenna 10 and fix the antenna 10 to the case 20. In addition, the terminal that connects the connector of the antenna and the conductive pad of the base may be a case connector integrated type terminal and the case main body 203 may have an internal structure (e.g., uneven structure) that supports the case connector integrated type terminal.

The base 30 may include a conductive pad, a printed circuit board, an antenna pad 303, a power input end 305 and an antenna output end 306. In the exemplary embodiment of the present embodiment, the base 30 may be an element configured to fix the case 20 to which the antenna 10 is connected, to a vehicle, and a shape or a thickness of the antenna pad 303 may be varied based on the types of vehicles where an antenna device may be mounted or the mounting locations of the antenna device.

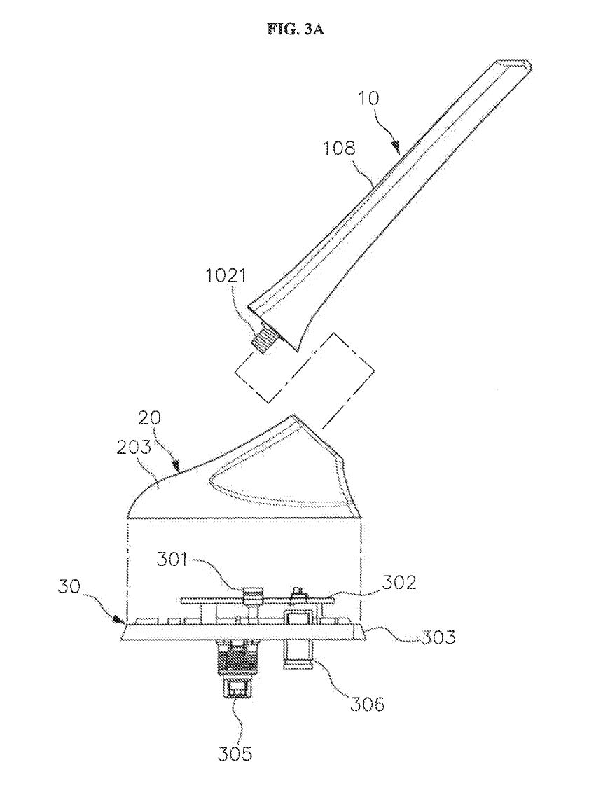

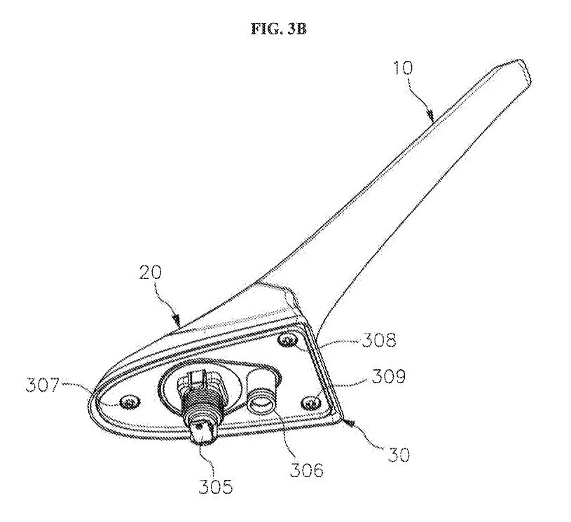

FIG. 3A is an exemplary detailed view showing a substantially small antenna device for a vehicle as shown in FIG. 2A and FIG. 3B is an exemplary bottom view showing a substantially small antenna device for a vehicle according to an exemplary embodiment of the present invention. Referring to FIGS. 3A and 3B, the antenna 10 may be separated from the case 20 and the case 20 may be separated from the base 30 by decoupling a plurality of fasteners 307, 308, 309. In particular, the mounting procedures of the antenna device may be as follows.

The base 30 may be fixed to arranging mounting location of a vehicle where an antenna may be mounted. The case 20 may be covered on an upper part of the base 30 to be fixed thereon. Specifically, when the base 30 is covered with the case 20, a remote end of the base connector integrated type terminal fixed within the case 20 may be in substantially close contact with the conductive pad 31 of the base 30. A thread portion 1021 of a connector of the antenna 10 may be fastened to the case connector exposed to an upper one side of the case 20 to complete a mounting of the antenna device.

When the base 30 is mounted on a vehicle, a specific product of an antenna pad 303 may be selected to match a vehicle based on the type of vehicle and a mounting location of the antenna device. For example, the base 30 may be mounted using the antenna pad to match with the corresponding vehicle among pre-designed antenna pads in various thicknesses based on the type of vehicle and the mounting location of the antenna device.

According to the configuration of the antenna pad as described above, the thickness and shape of the antenna pad may be pre-designed and adjusted to match with the curved shape on a mounting surface of the antenna device, to mount the antenna device stably to match with the vehicle.

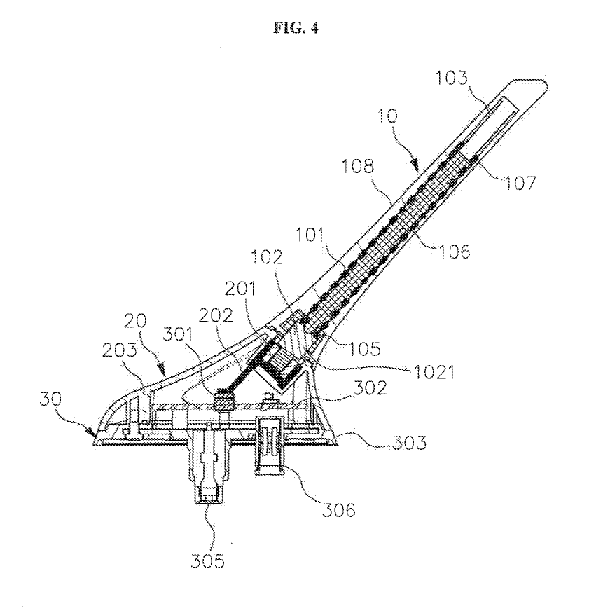

FIG. 4 is an exemplary cross-sectional view showing a substantially small antenna device for a vehicle as show in FIG. 2A. Referring to FIG. 4, the antenna 10 may include an antenna coil 101, a connector 102, a cylinder member 103, a first fixing member 105, a second fixing member 106, a third fixing member 107 and a cover member 108; the case 20 may include a case connector 201, a terminal 202 and a main body case 203; and the base 30 may include a conductive pad 301, a printed circuit board 302, an antenna pad 303, a power input end 305 and an antenna output end 306. The constitutional elements of the antenna 10 will be described in detail as followings.

The antenna coil 101 may be disposed in a helical antenna configuration at a predetermined pitch interval. The antenna coil 101 may be configured to receive a frequency signal of a radio band region. In addition, a thickness and a length of the antenna coil 101 may be designed in consideration of an impedance matching. The connector 102 may be disposed on one end (e.g., a first end) of the antenna coil 101. The connector 101 may be configured to transmit the radio frequency (RF) received by the antenna coil 101 to a radio frequency receiver (not shown) and transmit the radio frequency from a RF sender (not shown) to the antenna coil 101. In particular, the RF receiver or the RF sender may be disposed on a printed circuit board of the base 30 or a telecommunication device mounted within a vehicle and connected to the printed circuit board of the base 30.

The cylinder member 103 may be disposed on the other end (e.g., a second end) of the antenna coil 101 and may be electrically connected to the antenna coil 101. The cylinder member 103 may be formed with a cylindrical conductive pad that has a hollow portion or a conductive member and one end thereof may be formed to be smaller (e.g., smaller than the other end) and thus may be inserted into the other end of the antenna coil 101.

The first fixing member 105 may be configured to cover a portion of the connector and one end of the antenna coil 101 to fix the antenna coil 101 to the connector 102. The first fixing member 105 may be configured to connect the antenna coil 101 to the connector 102. Further, the first fixing member 105 may provide a firm connection to the cover member 108. For this purpose, the first fixing member 105 may include a pair of protrusions in a wing shape.

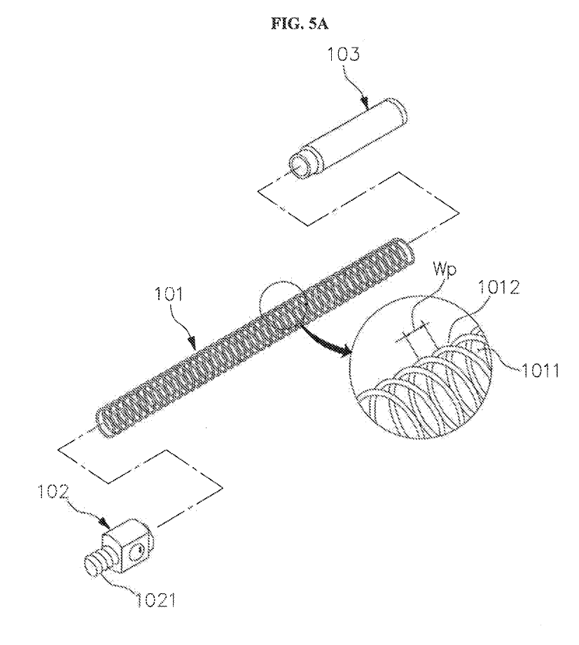

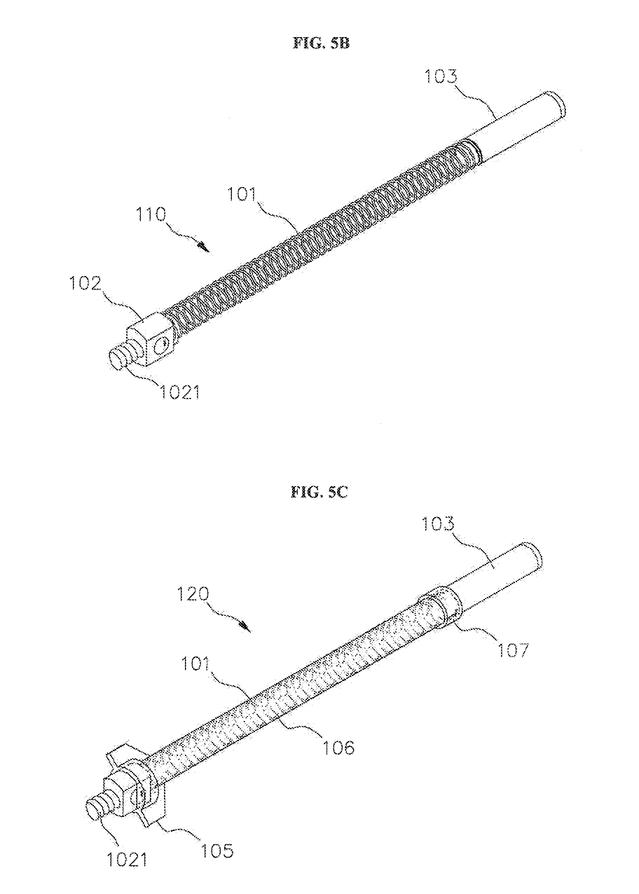

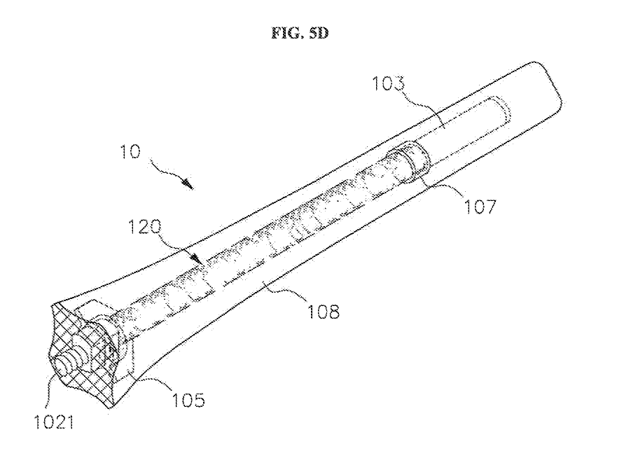

The second fixing member 106 may be filled in the hollow portion (see 1011 in FIG. 5A) of the antenna coil 101 and a gap within a substantially constant pitch interval (see 1012 in FIG. 5A). The second fixing member 106 may be integrally connected to the antenna coil 101 to cause the antenna coil 101 to maintain the substantially constant pitch interval. The second fixing member 106 may operate as a dielectric that has a predetermined dielectric constant, which may be connected to the antenna coil 101. The dielectric constant of the second fixing member 106 may be designed based on a frequency to be received and a thickness or a length of the antenna coil 101.

The third fixing member 107 may be configured to cover the other end of the antenna coil 101 into which a portion of the cylinder member 103 may be inserted to fix the cylinder member 103 to the antenna coil 101. The third fixing member 107 may include an uneven portion or a protrusion to firmly inter-connect the antenna coil 101, the cylinder member 103 and the cover member 108. The first to third fixing members 105, 106, 107 may be integrally formed through a single inject-forming process. In addition, the first to third fixing members 105, 106, 107 may be made of a predetermined insulating material and may operate as a dielectric that has a predetermined dielectric constant.

The cover member 108 may be configured to cover the antenna coil 101, the connector 102, the cylinder member 103, the first fixing member 105, the second fixing member 106 and the third fixing member 107, except for the screw thread portion 1021 of the connector 102. The cover member 108 may have a length of about 110-130 mm and may protect the inside of the antenna 10 from an external side and may be arranged to have proper design for arranging mounting environment. Further, the cover member 108 may be a sheath for the antenna 10 and may be made of an insulating material that has increased durability with respect to external temperature changes, rain and wind. For this purpose, the cover member 108 may be manufactured by single inject-forming process that forms the predetermined material for a sheath to cover an antenna module including of the antenna coil 101, the connector 102, the cylinder member 103, the first fixing member 105, the second fixing member 106 and the third fixing member 107.

In the exemplary embodiment of the present embodiment, even the first fixing member 105, the second fixing member 106 and the third fixing member 107 are described to be integrally formed by a single injection process, the present invention is not limited thereto. In other words, when the cylinder member 103 is not necessary to be fixed to the antenna coil 101, or the cylinder member 103 is not used, the first fixing member 105 and the second fixing member 106, may be integrally formed (e.g., without the third fixing member 107).

Furthermore, the constitutional elements of the case 20 and the base 30 will be described in detail as followings.

The case connector 201 may include an inter-fastening structure with respect to the connector 102 of the antenna 10. For example, the case connector 201 may include a nut type screw thread portion to be screwed to a bolt type screw thread portion (see 1021 in FIG. 5A) of the connector 102 in a hollow portion or a concave portion thereof. The case connector 201 may be fixedly supported on one upper side of the case 20 by an internal structure of the case 20.

The terminal 202 may be integrally formed with the case connector 201 and may be extended toward an internal center of the case 20 to a predetermined length in a substantially straight line shape. The terminal 202 may be made of a conductive material and may be integrally formed with the case connector 201. For example, the terminal 202 may surround at least a portion of an outer peripheral surface of the case connector 201, or may pass through at least a portion of the case connector 201 to be exposed to the inside thereof. When the terminal 202 is exposed to a hollow portion of the case connector 201, the terminal 202 may be electrically connected to the antenna coil 101 through the connector 102 of the antenna 10 (e.g., not through the case connector 201). Additionally, when the terminal 202 is extended to a predetermined length in a substantially straight line shape, the terminal 202 may be in contact with the conductive pad 301 disposed on an upper part of the base 30 by covering the case 20 over an upper surface of the base 30 after fixing the base 30 to a vehicle.

Meanwhile, even though it is described that the terminal 202 may be extended in a substantially straight line shape in the exemplary embodiment of the present embodiment only for convenience in description and illustration, it is not limited thereto, and thus the shape and configuration of the terminal 202 may be varied as long similar effects are obtained to when the terminal that is extended in a substantially straight line shape. For example, a remote end of the terminal 202 may be curved at a predetermined angle, a contact surface of the remote end thereof may be curved, and the substantially straight extended portion thereof may be curved at least one time as an arc shape or a combination shape of the arcs, to contact the conductive pad 301.

The case main body 203 may be configured to support the case connector 201 and the terminal 202 and cover an upper part of the base 30. In particular, the combination of the case connector 201 and the terminal 202 may correspond to the terminal integrated type case connector or the case connector integrated type terminal. The case main body 203 may form an outer surface of the case 20 and may be formed with exterior material. Additionally, the case 20 may include a supporting structure (e.g., uneven structure, etc.) configured to support the case connector integrated type terminal or a structure to assemble the case connector integrated type terminal therein more easily.

The conductive pad 301 may be disposed to have an upper surface in contact with the terminal 202. Further, the conductive pad 301 may be electrically connected to a predetermined wire. In particular, the wire may be configured to electrically connect the conductive pad 301, the RF receiver, and the RF sender, respectively.

The printed circuit board 302 may be configured to support the conductive pad 301. The printed circuit board 301 may have a configuration in which the wire pattern to which the conductive pad 301 is electrically connected may be printed. In addition, the printed circuit board 302 may be arranged as multi-layers (e.g., two layers) and the conductive pad 301 may be disposed on an upper end of the multi-layers and the lower end of the multi-layers may operate as a support substrate to support entire base 30.

The antenna pad 303 may be connected to a lower surface of the printed circuit board 302 and may be configured to cover a lower surface of the case 20. The antenna pad 303 may be disposed between a vehicle body and the case 20, and may be made of an elastic material. In addition, the antenna pad 303 may be detachably connected to the support substrate of the printed circuit board 302 to replace the antenna pad 303 more easily based on the type of vehicle and the mounting location of the antenna device.

The power input end 305 may be configured to support a mechanical connection of a vehicle body and the base 30, and may be configured to supply power to the printed circuit board 302 from an external device (e.g., telecommunication device mounted on a vehicle, etc.). The power input end 305 may include an electric wire therein and an insulator that surrounds the electric wire, and may include power connection terminals at both ends thereof. The power input end may pass through the antenna pad 303 and electrically connect an external power source and the printed circuit board 302.

The antenna output end 306 may form a wire path from the conductive pad 301 of the base 30 to the telecommunication device mounted within the vehicle. The antenna output end 306 may have a tube shape having a hollow portion through which the wire passes, and may be spaced from the power input end 305 at a predetermined distance to pass through a center opening of the antenna pad 303.

According to the exemplary embodiment of the present embodiment, a substantially small antenna device for a vehicle may be manufactured at a reduced manufacturing cost, through which a frequency at a radio band region may be received via the antenna coil 101 and the cylinder member 103.

FIGS. 5A-5D are exemplary views showing a manufacturing method of a substantially small antenna device for a vehicle as shown in FIG. 4. In FIGS. 5C and 5D, at least a portion of some components is shown to be transparent for convenience in description thereof.

A manufacturing method of a substantially small antenna device for a vehicle according to an exemplary embodiment of the present invention, as shown in FIG. 5A, may include: preparing an antenna coil 101 in a helical shape, wherein the antenna coil 101 has a hollow portion 1011 and a pitch space portion 1012 formed by a predetermined pitch Wp, a connector 102, and a cylinder member 103; and bonding the connector 102 to one end of the antenna coil 101. As shown in FIG. 5B, an antenna core 110 including the antenna coil 101, the connector 102 and the cylinder member 103 may be prepared through the bonding process.

Further, as shown in FIG. 5C, an antenna module 120 may be prepared by integrally forming a first fixing member 105, a second fixing member 106 and a third fixing member 107 to the antenna core 110. In particular, the first fixing member 105, the second fixing member 106 and the third fixing member 107 may be integrally formed through a single inject-forming process while the antenna module 120 is prepared.

The first fixing member 105 may be configured to cover a portion of the connector and one end of the antenna coil to fix the antenna coil 101 to the connector 102; the second fixing member 106 may be filled in the hollow portion and the pitch space of the antenna coil 101; and the third fixing member 106 may be configured to cover the other end of the antenna coil 101. The first fixing member 105 may operate as a fixing piece configured to fix the antenna coil 101 to the connector 102; the second fixing member 106 may operate as a dielectric filled in the hollow portion and the pitch space of the antenna coil 101; and the third fixing member 107 may operate as a fixing band configured to fix the cylinder member 103 to the antenna coil 101.

As shown in FIG. 5D, the antenna module 120 that includes the connector, the antenna coil, the cylinder member, the first fixing member, the second fixing member and the third fixing member may be covered with the cover member 108, except for the protruded screw-thread portion 1021. The cover member 108 may be formed with a predetermined material for a sheath through a single inject-forming process. In addition, the manufacturing method may include preparing a case connector 201 having an inter-fastening structure with respect to the connector 102 of the antenna 10 and a base having a base connector integrated type terminal extended in a substantially straight line to one direction from the case connector 201.

Further, the manufacturing method may include preparing a base having a substrate, an upper surface of which may be covered by the case 20, that may be connected to a lower surface of the substrate and may have a shape and thickness pre-set based on a vehicle type and the mounting location of the antenna device.

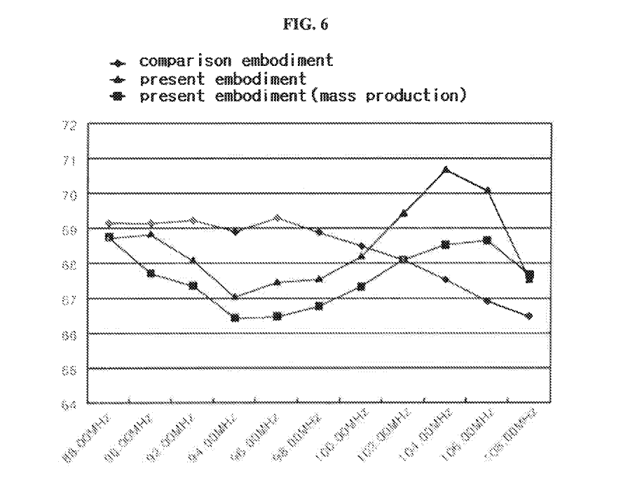

FIG. 6 is an exemplary graph showing receiving performances of a substantially small antenna device for a vehicle according to an exemplary embodiment of the present invention and a helical antenna having a pole type antenna of about 200 mm according to a related art.

Referring to FIG. 6, a substantially small antenna device for a vehicle according to an exemplary embodiment of the present invention may exhibit electric properties (e.g., profit, directivity, etc.) substantially equal to those of a conventional pole type helical antenna in a length of about 200 mm over substantially the entire band region of a frequency from about 88 Hz to 108 Hz. As shown in FIG. 6, the signal receiving performance of the antenna of the present invention over a frequency band region of AM and FM is not reduced in comparison to the conventional pole type helical antenna.

As described above, the substantially small antenna device for a vehicle and the manufacturing method thereof according to the present invention are configured such that an insulator having a predetermined dielectric capacity may be inserted into an antenna coil of a helical antenna configuration and at the same time a cylinder member having a conductive pad may be mounted to one end of the antenna coil to maintain the electric properties of the antenna despite the reduced size of the antenna. According to the exemplary embodiment of the present invention, the manufacturing cost of the antenna may be reduced through the simplified manufacturing process and a length of the antenna may be decreased to form a smaller appearance based on a vehicle type.

In addition, according to the substantially small antenna device of the present invention, an inject-forming process of a bobbin may be omitted to reduce the number of the components and to simplify the manufacturing process, thereby lowering the price of the product. The appearance of the antenna may also be improved and a freedom degree of designing the appearance of the antenna may increase by removing a spiral protrusion structure disposed on the exterior of a cover member, to prevent wind noise.

While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the accompanying claims.

What is claimed is:

1. An antenna device for a vehicle, comprising:
an antenna coil arranged in a helical antenna shape having a substantially constant pitch interval;
a connector disposed on a first end of the antenna coil;
a cylinder member disposed on a second end of the antenna coil and electrically connected to the antenna coil;
a first fixing member configured to cover a portion of the connector and the first end of the antenna coil to fix the antenna coil to the connector;
a second fixing member filled into a hollow portion and a gap within the substantially constant pitch interval of the antenna coil;
a third fixing member configured to cover the second end of the antenna coil; and
a cover member configured to cover the antenna coil, a portion of the connector, the cylinder member, the first fixing member, the second fixing member and the third fixing member,
wherein the first fixing member, the second fixing member and the third fixing member are integrally formed.

2. The antenna device for a vehicle of claim 1, further comprising:
a case to which the connector is connected,
wherein the case includes a terminal integrated type case connector.

3. The antenna device for a vehicle of claim 1, further comprising:
a case to which the connector is connected,
wherein the case includes:
a case connector having an inter-fastening structure with respect to the connector; and
a terminal integrally formed with the case connector and extended to one direction in a substantially straight line shape.

4. The antenna device for a vehicle of claim 3, further comprising a base, an upper surface of which is covered with the case, wherein the base includes:
a conductive pad electrically connected to the terminal;
a printed circuit board configured to support the conductive pad;
an antenna pad connected to a lower surface of the printed circuit board and configured to cover a lower surface of the case;
a power input end that passes through the antenna pad to be connected to the printed circuit board and configured to supply power to the printed circuit board; and
an antenna output end spaced from the power input end at a predetermined interval to pass through the antenna pad and form a wire path from the printed circuit board to exterior.

5. The antenna device for a vehicle of claim 4, wherein the antenna pad is detachably disposed to the base and a shape and a thickness of the antenna pad are variously formed based on mounting locations of the antenna based on a vehicle type.

6. A manufacturing method of an antenna for a vehicle, comprising:
bonding a connector to a first end of an antenna coil disposed in a helical antenna shape having a substantially constant pitch interval;
bonding a cylinder member having a conductive pad electrically connected to the antenna coil to a second end of the antenna coil;
integrally inject-forming a first fixing member configured to cover a portion of the connector and the first end of the antenna coil to fix the antenna coil to the connector, a second fixing member filled into a hollow portion and a gap within the substantially constant pitch interval of the antenna coil, and a third fixing member configured to cover the second end of the antenna coil; and
inject-forming a cover member configured to cover the antenna coil, a portion of the connector, the cylinder member, the first fixing member, the second fixing member and the third fixing member.

7. The manufacturing method of an antenna for a vehicle of claim 6, further comprising:
providing a case that includes:
a case connector having an inter-fastening structure with respect to the connector; and
a case connector integrated type terminal extended to one direction in a substantially straight line shape.

8. The manufacturing method of an antenna for a vehicle of claim 7, further comprising:
providing a base that includes a printed circuit board, an upper surface of which is covered with the case, connected to a lower surface of the printed circuit board and having preset various shapes and thicknesses based on mounting locations of the antenna and a vehicle type.
